(19) United States
(12) Patent Application Publication
(10) Pub. No.: US 2025/0058809 A1
(43) Pub. Date: Feb. 20, 2025

(54) Pallet Mobilizer System and Method

(71) Applicant: HDT Expeditionary Systems, Inc., Solon, OH (US)

(72) Inventors: Charles Deighton, Milford, OH (US); Wade Milek, Mason, OH (US)

(73) Assignee: HDT Expeditionary Systems, Inc., Solon, OH (US)

(21) Appl. No.: 18/803,432

(22) Filed: Aug. 13, 2024

Related U.S. Application Data
(60) Provisional application No. 63/532,658, filed on Aug. 14, 2023.

(51) Int. Cl. B62B 3/00; B62B 3/10; B65G 7/04

(52) U.S. Cl. CPC B62B 3/002; B62B 3/108; B65G 7/04; B62B 2206/06

(57) ABSTRACT

A pallet mobilizer for engaging and moving an associated pallet on a support surface includes a first wheeled assembly including a first frame including a first receiver adapted to be engaged with a first edge of the associated pallet, and includes a second wheeled assembly including a second frame including a second receiver adapted to be engaged with a second edge of the associated pallet that is parallel to and spaced-apart from the first edge. The pallet mobilizer also includes a first side rail adapted to be located adjacent a third edge of the associated pallet, the first side rail connected to and extending between the first and second frames. The pallet mobilizer further includes a second side rail adapted to be located adjacent a fourth edge of the associated pallet, the second side rail connected to and extending between the first and second frames.

### CROSS-REFERENCE TO RELATED APPLICATION

This application claims priority from and benefit of the filing date of U.S. provisional application Ser. No. 63/532,658 filed Aug. 14, 2023, and the entire disclosure of said provisional application is hereby expressly incorporated by reference into the present application.

### BACKGROUND

The 463L pallet is a widely used platform for transporting cargo within the military with many tens of thousands in circulation worldwide. The 463L pallet is an aircraft certified transport platform that can be loaded with food, supplies, and equipment. As a standard item, the 463L pallet allows for a vast number of unique items to be shipped using standard methods making for more effective and efficient shipping. The 463L pallet is a standard military-specification certified design. It's size, shape, features, and load carrying capacity is per the military specification. The 463L is designed to be thin, light, and strong so it does not add additional burden to shipping by consuming space and load capacity. Although the features of the 463L pallet are ideal for aircraft and transport vehicles as they have specifically designed mating interfaces, once the pallet is placed on a support surface such as the ground or floor, the pallet can be difficult to move. Specifically, it is difficult get the forks/tines of a forklift under the 463L pallet without providing blocking or “dunnage” underneath the pallet for the pallet to sit on such that the pallet is spaced above the support surface to allow the forks of the forklift to be inserted underneath the pallet to engage and lift the pallet. Also, the 463L pallet can be loaded with 10,000 lbs. which requires a large forklift to load the pallet onto and/or remove the pallet from an aircraft or land vehicle. In some cases, personnel must manually remove and carry items from the pallet if the proper forklift is not available. The military operates at some very small bases or places that have no material handling equipment. At these locations there are 3 main options for getting the 463L pallet of material off the aircraft or other vehicle:
1. manually unload the cargo from the pallet;
2. transfer the cargo into 55-gallon barrels or other containers for offload,
3. drag the fully loaded pallet off of the aircraft/vehicle.
   Each of these methods and similar methods for unloading (or the reverse process for loading) is suboptimal in terms of the personnel required, the time required, possible damage to the cargo and/or to the pallet and/or to the aircraft/vehicle. The problem is exacerbated by the fact that military operational tactics are switching toward using smaller temporary bases or “CLs” that have minimal equipment, often with no suitable material handling equipment for moving loaded or unloaded 463L pallets.

### SUMMARY

In accordance with one aspect of the present development, a pallet mobilizer for selectively engaging and moving an associated pallet on a support surface includes first and second wheeled assemblies and first and second side rails, wherein the first and second wheeled assemblies include respective first and second receivers for selectively engaging wedge interface members located on the associated pallet, and wherein the first and second wheeled assemblies can be arranged in opposed facing relation on opposite first and second sides of the associated pallet and the first and second side rails can be arranged in opposed facing relation on opposite third and fourth sides of the associated pallet, with the first and second side rails extending between and connected to both the first and second wheeled assemblies.

In accordance with another aspect of the present development, a method of mobilizing a pallet includes engaging the pallet with first and second wheeled assemblies that movably support the pallet on a support surface. A first receiver provided on the first wheeled assembly is engaged with a first edge of the pallet and a second receiver provided on the second wheeled assembly is engaged with a second edge of the pallet that is opposite the first edge of the pallet.

In accordance with a further aspect of the present development, a pallet mobilizer for selectively engaging and moving an associated pallet on a support surface includes a first wheeled assembly including a first frame including a first receiver adapted to be located adjacent and engaged with a first edge of the associated pallet. The pallet mobilizer further includes a second wheeled assembly including a second frame including a second receiver adapted to be located adjacent and engaged with a second edge of the associated pallet that is parallel to and spaced-apart from the first edge. The pallet mobilizer also includes a first side rail adapted to be located adjacent a third edge of the associated pallet, the first side rail connected to and extending between the first and second frames. The pallet mobilizer also includes a second side rail adapted to be located adjacent a fourth edge of the associated pallet, the second side rail connected to and extending between the first and second frames.

### BRIEF DESCRIPTION OF THE DRAWINGS

FIG. 1 (prior art) is an isometric view that shows a conventional military logistics pallet.

FIG. 1A (prior art) is an enlarged partial view of the pallet of FIG. 1.

FIG. 2A provides an exploded view of a pallet mobilizer formed in accordance with an embodiment of the present development.

FIG. 2B provides a partially exploded view of the pallet mobilizer of FIG. 2A operably engaged with an associated pallet such as the pallet of FIG. 1.

FIG. 3 is a fully assembled isometric view of the pallet mobilizer of FIGS. 2A and 2B operatively engaged with an associated pallet such as the pallet of FIG. 1.

FIG. 4 is a side view of the fully assembled pallet mobilizer and pallet of FIG. 3.

FIG. 5 is a front view of the fully assembled pallet mobilizer and pallet of FIG. 3 (the rear view is identical).

FIG. 6 which shows a wheeled assembly portion of the pallet mobilizer.

FIG. 7 is an enlarged partial isometric view of the wheeled assembly of FIG. 6.

FIG. 8 is an enlarged partial side view of the wheel assembly of FIG. 6 engaged with an associated pallet.

FIG. 9 provides an isometric view of a side rail frame from portion of the pallet mobilizer.

FIG. 10 is an isometric view of the pallet mobilizer arranged in a packed or stowed configuration.

FIG. 11 is a side view of the packed/stowed pallet mobilizer of FIG. 10.

FIG. 12 is a partial isometric view from above of the packed/stowed pallet mobilizer of FIG. 10.

FIG. 13 shows the pallet mobilizer arranged in its packed/stowed configuration supported on an associated floor or ground surface with its brakes engaged.

FIG. 14 is similar to FIG. 13 but shows that the jack assemblies of each wheeled assembly can be selectively operated to raise the frame of each wheeled assembly and the brakes can be disengaged to allow the pallet mobilizer, in its stowed or packed configuration, to be manually pushed or otherwise moved across the associated floor or ground surface.

FIG. 15 shows the packed/stowed pallet mobilizer operably connected to an associated tow vehicle by a tow bar for towing movement of the pallet mobilizer on the associated floor or ground surface.

FIG. 16 shows that each wheeled assembly can be arranged or placed such that its frame contacts the floor or ground when not in operative use.

FIG. 17 shows that a maneuvering dolly of each wheeled assembly can be selectively extended to allow the wheeled assembly to be easily rolled and maneuvered across the associated floor or ground surface (a pallet including cargo thereon is also supported on the associated floor/ground surface).

FIG. 18 shows that the maneuvering dolly of each wheeled assembly can be adjusted to position the pallet receiver of the wheeled assembly at a proper height relative to the associated floor/support surface for operatively engaging an associated pallet.

FIG. 18A is an enlarge view of detail region 18A of FIG. 18.

### DETAILED DESCRIPTION

A pallet mobilizer PM provided in accordance with an embodiment of the present development is disclosed in Exhibit A which forms a part of this specification. As described in Exhibit A, the pallet mobilizer PM can be selectively operatively connected to an associated 463L pallet P to form a pallet mobilizer system PS comprising the pallet mobilizer PM operatively connected to the pallet P. When operatively connected to the pallet P as described to form the pallet mobilizer system PS, the pallet mobilizer system including the pallet mobilizer and associated pallet can be rolled manually or be towed across a support surface such as the ground, a floor, an aircraft ramp, and the like. The present disclosure also relates to a method for mobilizing a pallet such as a 463L pallet.

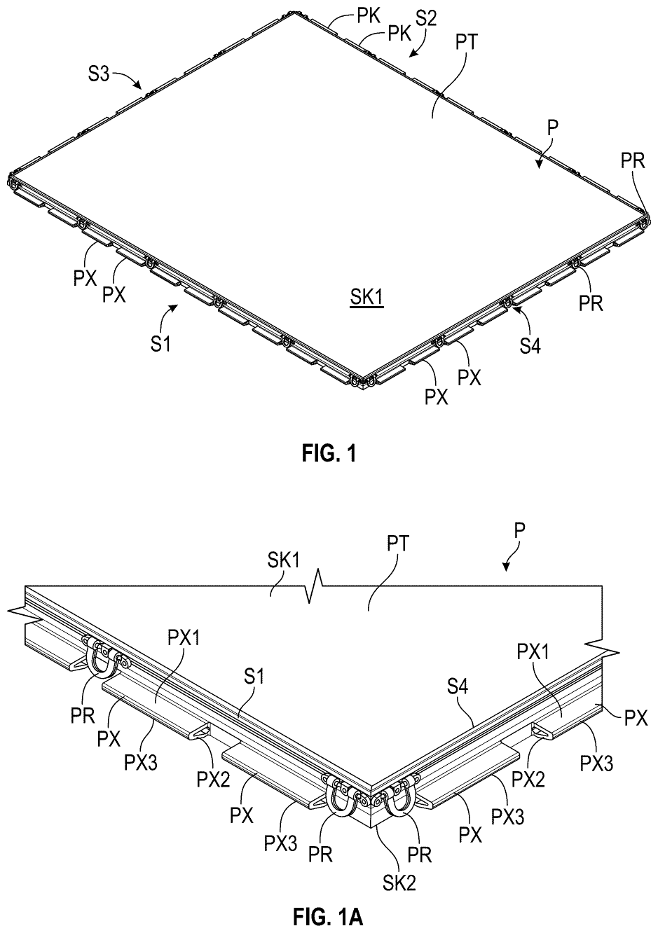

The pallet mobilizer PM is further disclosed with reference to the drawings. FIG. 1 (prior art) is an isometric view that shows a conventional 463L pallet P as is generally known in the art of military logistics. FIG. 1A (prior art) is an enlarged partial view of the pallet P of FIG. 1. The pallet P is rectangular in shape and comprises: (i) a cargo platform PT for supporting cargo; (ii) first and second parallel and spaced-apart sides or edges S1,S2; and (iii) third and fourth parallel and spaced-apart sides or edges S3,S4 that respectively extend between and interconnect the opposite ends of the first and second sides S1,S2. The cargo support platform PT can comprise a balsa wood core faced on opposite sides by top and bottom aluminum skins SK1,SK2 that respectively provide top (upper) and bottom (lower) surfaces of the platform PT. The first and second sides S1,S2 can be longer than the third and fourth sides S3,S4. The four sides S1-S4 together form a rectangular perimeter for a platform P.

Referring also to the partial enlarged view of FIG. 1A, each of the sides S1-S4 comprises a plurality of individual wedge interface members PX that are spaced apart from each other and arranged in series along the entire side S1-S4 and that each project outwardly away from a center of the cargo platform PT Each wedge interface member PX comprises an upper wedge surface PX1 arranged generally parallel to the top surface SK1 of the cargo platform PT and an opposite lower wedge surface PX2 that converges toward the upper wedge surface PX1 as it extends outwardly away from the cargo platform PT. The upper and lower wedge surfaces PX1, PX2 are joined together at their respective outer ends to form a nose PX3 of the wedge interface member X. In terms of the relative location of the upper and lower wedge surfaces PX1, PX2 with respect to the top and bottom surfaces SK1,SK2 of the platform PT, the upper wedge surfaces PX1 includes an inner end that is connected to the platform edge between the top and bottom surface SK1,SK2 (approximately midway between the top and bottom surface SK1,SK2) while the inner end of the lower wedge surface PX2 is connected to the edge of the platform PT adjacent the lower surface SK2, i.e., closer to the lower surface SK2 as compared to the upper surface SK1. The sides S1-S4 of the pallet each include a plurality of pivoting or hinged tie-down rings PR.

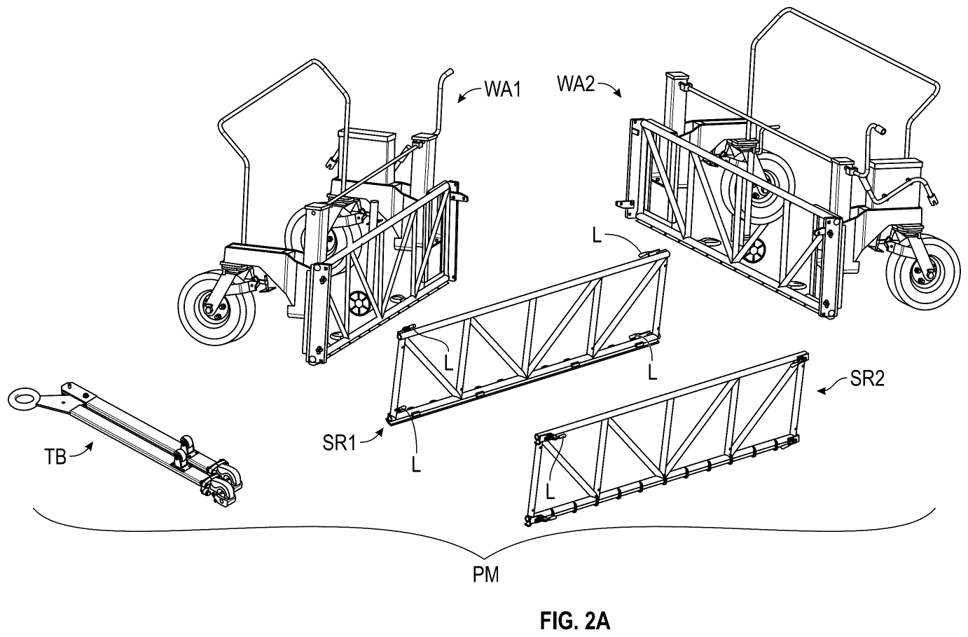

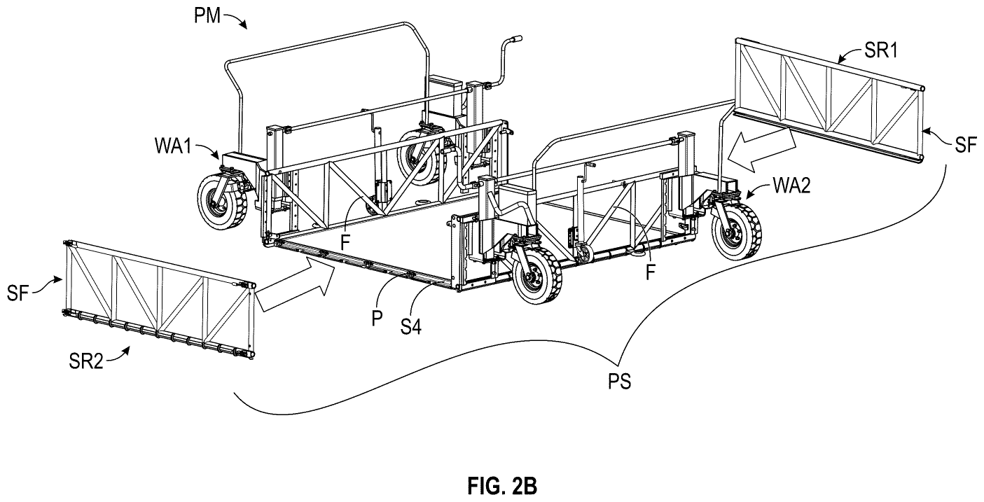

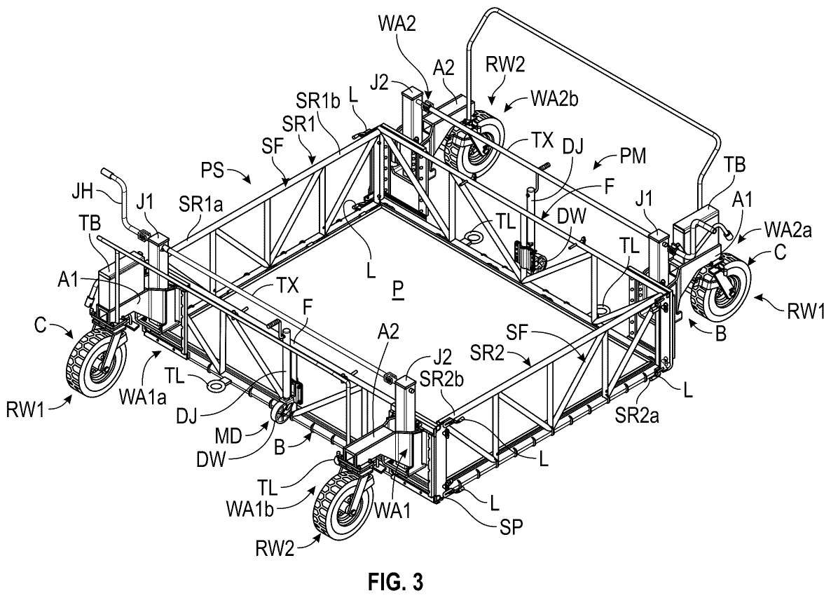

FIG. 2A provides an exploded view of a pallet mobilizer PM formed in accordance with an embodiment of the present development. The pallet mobilizer PM comprises first and second wheeled assemblies WA1,WA2 and first and second side rails SR1,SR2. An optional tow bar TB can also be provided. As shown in FIG. 2B, the first and second wheeled assemblies WA1,WA2 and the first and second side rails SR1,SR2 are selectively operably connected to each other and to an associated 463L pallet P to form pallet mobilizer system PS (FIG. 3) comprising the pallet P operatively connected to the pallet mobilizer PM for rolling movement of the pallet P across a support surface.

FIGS. 3-5 shows the first and second wheeled assemblies WA1,WA2 and first and second side rails SR1,SR2 connected to each other in an operative configuration engaged with an associated pallet P so that the pallet mobilizer PM extends coextensively around the rectangular perimeter of the pallet P, with each of the first and second wheeled assemblies WA1,WA2 and side rails SR1,SR2 operatively engaged with the pallet P so that the pallet P can be transported or mobilized across the ground, floor, or other support surface using the pallet mobilizer PM. In its operative configuration, the first and second wheeled assemblies WA1,WA2, which can be structured identically to each other or which can be differently structured with respect to each other, are respectively engaged with the first and second sides S1,S2 of the pallet P so as to be arranged in opposed, parallel facing relation with respect to each other. Likewise, the first and second side rails SR1,SR2, which can be structured identically to each other or which can be differently structured with respect to each other, are respectively engaged with the third and fourth sides S3,S4 of the pallet P so as to be arranged in opposed, parallel facing relation with respect to each other and so as to each be arranged perpendicularly with respect to the first and second wheeled assemblies WA1,WA2.

Connection of each of the first and second side rails SR1,SR2 to each of the first and second wheeled assemblies WA1,WA2 maintains these components SR1,SR2,WA1,WA2 in a fixed operative position relative to each other. The pallet mobilizer PM can be assembled into this operative position, with or without the pallet P being engaged thereby (as disclosed in detail below), by fixedly securing or fastening the wheeled assemblies WA1,WA2 and side rails SR1,SR2 together in an endless series in the described rectangular configuration. Thus, a first end SR1a of the first side rail SR1 is connected to a first lateral side WA1a of the first wheeled assembly WA1 and an opposite second end SR1b of the first side rail SR1 is connected to a second lateral side WA2b of the second wheeled assembly and WA2. Correspondingly, a first end SR2a of the second side rail SR2 is connected to a first lateral side WA2a of the second wheeled assembly WA2 and an opposite second end SR2b of the second side rail SR2 is connected to a second lateral side WA1b of the first wheeled assembly WA1. The side rails SR1,SR2 and wheeled assemblies WA1,WA2 can be selectively connected in the operative configuration using any suitable connecting or fastening structures and/or methods such as fasteners, clips, pins, structurally interfitted members, and/or other known fastening or connecting means or structures. In the illustrated embodiment, the side rails SR1,SR2 are selectively connected to the wheeled assemblies WA1,WA2 in the described operative configuration using primary latches L that are engaged and act between the side rails SR1,SR2 and the wheeled assemblies WA1,WA2 when the side rails SR1,SR2 and wheeled assemblies WA1,WA2 are positioned in the operative rectangular configuration (preferably with at least two vertically spaced-apart latches L provided for each interface between a side rail SR1,SR2 and a wheeled assembly WA1,WA2). For each latch L, a first mating component of the latch L can be connected to the side rails SR1,SR2 and a second mating latch component connected to the wheeled assemblies WA1,WA2, or vice versa, as desired for any particular latch L. The pallet mobilizer PM also comprises safety pins SP that are inserted into aligned apertures AP of the wheeled assemblies WA1,WA2 and the side rails SR1,SR2 to prevent separation of the side rails SR1,SR2 from the wheeled assemblies WA1,WA2 in the event a latch L fails or unlatches.

As noted above, the first and second wheeled assemblies WA1,WA2 can be identically or similarly formed with respect to the components described herein so as to be interchangeable with each other. Likewise, the first and second side rails SR1,SR2 can be identically or similarly formed with respect to the components described herein so as to be interchangeable with each other.

With continuing reference to FIGS. 3-5 and also FIG. 6 which shows the wheeled assembly WA1,WA2 by itself, each of the first and second wheeled assemblies WA1,WA2 comprises a body B including a chassis C and a pallet engaging frame F movably connected to and supported by the chassis C. The chassis C includes first and second laterally spaced-apart support rails or support arms A1,A2 which can be steel, aluminum or another metal, and the frame F, which is also preferably steel, aluminum, or another metal, extends between the first and second support arms A1,A2 such that the support arms A1,A2 are respectively located on opposite first and second lateral sides of the frame. The frame F is slidably connected to the support arms A1,A2 such that the frame F can be raised and lowered relative to the support arms A1,A2 so that the frame F can be selectively moved toward and away from the ground, floor, or other support surface.

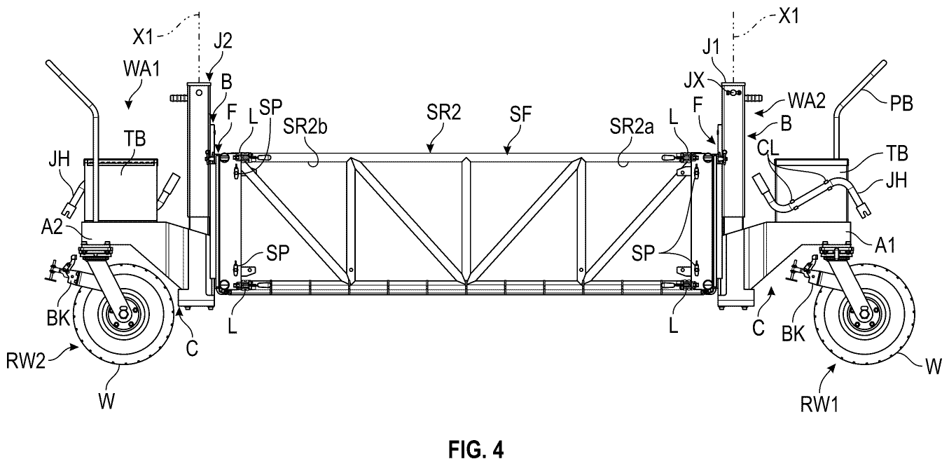

At least one and preferably first and second jack assemblies J1,J2 (generally J) are operatively connected between the chassis C and the frame F and are selectively operated in first and second directions to move the frame in respective first and second directions to the raise and lower the frame F relative to the chassis C. In the illustrated embodiment, each jack assembly J (J1,J2) includes: (i) a first portion fixedly secured to the frame F; and (ii) a second portion fixedly secured to the chassis C such as to a support arms A1,A2. The first and second jack portions of each jack assembly J are telescopically engaged with each other, and each jack assembly J further includes a linear actuator such as a jackscrew or other actuator that converts rotational input torque to applied at a jack input JX into linear movement of the first and second jack portions along a respective lift axis X1 (FIGS. 4 & 5), with the direction of telescoping movement (extension or retraction) depending upon the direction of rotation of the jack input JX. In the illustrated example, the jack inputs JX are interconnected by a torque transfer bar TX such that torque applied to the jack input JX of a jack assembly J1 is transferred through the torque transfer bar TX to the torque input JX of the other jack assembly J2 and vice versa. In response to operative the jack assemblies J1,J2, the frame F moves linearly in a plane that lies parallel to a plane that contains the respective lift axes X1 of the first and second jack assemblies J1,J2. The pallet mobilizer PM further comprises a jack handle JH that can be selectively operatively connected to the jack input JX for manual application of torque to the jack input JX. The chassis C can also include at least one tool box such as the hinged-lid tool box TB connected to a support arm A1,A2 or elsewhere that can be used to hold the jack handle JH and other items such as a battery-operated drill or other battery-operated power tool for being selectively engaged with the jack input JX for rotating same to selectively extend and retract the jack assemblies J1,J2. In the illustrated embodiment, one or more handle retaining clips CL (FIG. 4) are connected to the outside of the toolbox and selectively engage and retain the jack handle JH in an inoperative position connected to the toolbox TB when it is not in its operative position engaged with the jack input JX.

The frame F of each wheeled assembly WA1,WA2 can be constructed from a plurality of metallic members such as steel or aluminum alloy that are welded or otherwise interconnected so as to define a respective cargo retaining fence that extends completely and uninterrupted along the side S1,S2 of the pallet P when the wheeled assemblies WA1,WA2 are operatively engaged with the pallet P. The side rails SR1,SR2 each also comprise a frame SF that is substantially similar to the frame F of each wheeled assembly WA1,WA2. As such, each side rail frame SF is constructed from a plurality of metallic members such as steel or aluminum alloy that are welded or otherwise interconnected so as to define cargo retaining fences that respectively extend completely and uninterrupted along the side S3,S4 of the pallet P when the side rails SR1,SR2 are operatively engaged with the pallet P. The frames F, SF extend perpendicularly upwardly away from the upper surface SK1 of the pallet P when the wheeled assemblies WA1,WA2 and side rails SR1,SR2 are operatively engaged with the pallet P such that the fences frames F,SF together extend continuously and uninterruptedly around the entire perimeter of the pallet P and define a closed wall structure to restrain cargo supported on the pallet P.

The first and second wheeled assemblies WA1,WA2 each further comprise at least one rolling wheel assembly RW1,RW2 connected to chassis C for movably supporting the chassis C for movement across any type of support surface such as a floor, ramp, or a ground surface. In the illustrated embodiment, first and second rolling wheel assemblies RW1,RW2 are respectively connected to the first and second support arms A1,A2 of the chassis C. The or each rolling wheel assembly RW1,RW2 can be a caster wheel assembly as shown comprising a wheel W supported for rotation about a horizontal rolling axis and also supported rotation or pivoting movement about a pivot axis that lies perpendicular to the horizontal rolling axis to allow for omnidirectional rolling movement of the wheel W in any desired direction on the support surface. The caster wheels RW1,RW2 can be selectively pinned or otherwise restrained in a fixed position about the pivot axis to provide for more controlled rolling movement, especially when the pallet mobilizer PM is being towed by a vehicle V. The wheel W can be a pneumatic tire, a solid wheel or roller such as a solid polymeric wheel or roller made from polyurethane or the like. In the illustrated embodiment, each wheeled assembly WA1,WA2 includes first and second laterally spaced-apart rolling wheel assemblies RW1,RW2 that are respectively located on the opposite lateral sides of the chassis C, but each or either one of the first and second wheeled assemblies WA1,WA2 can alternatively include only one rolling wheel assembly RW1,RW2 or more than two rolling wheel assemblies RW1,RW2 without departing from the overall scope and intent of the present development. At least one of and optionally all of the rolling wheel assemblies RW1,RW2 includes a selectively activated brake BK that can be pivoted or otherwise moved with a user's foot or otherwise selectively into an engaged position where the brake is physical engaged or abutted with the rolling wheel W to prevent or at least inhibit rotation of the wheel W about its rolling axis to prevent undesired movement of the pallet mobilizer system PS. The brake BK can be moved selectively with a user's foot or otherwise from the engaged position to a disengaged position when the brake is spaced-apart from and disengaged from the wheel W to allow free rolling movement of the wheel W.

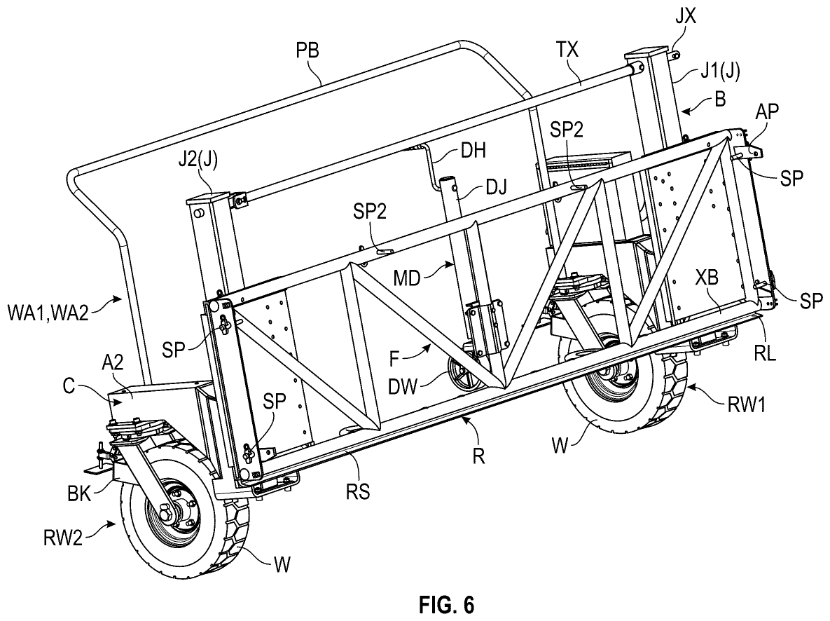

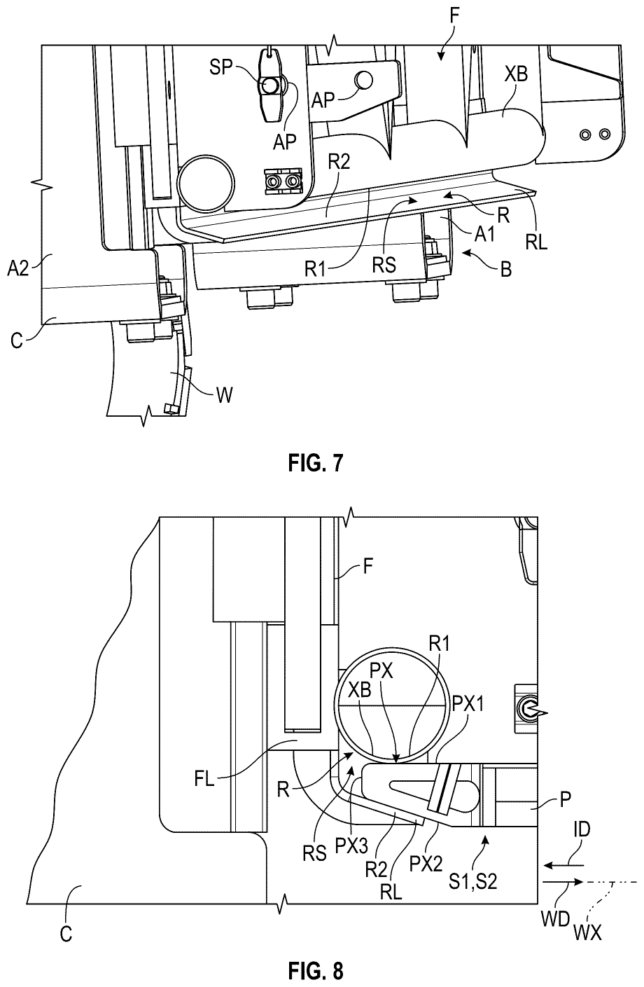

The frame F of each wheeled assembly WA1,WA2 includes a wheeled assembly pallet receiver R (FIGS. 6-8) that selectively mates with and engages at least two and preferably multiple or all of the wedge interface members PX on the first or second side S1,S2 of the pallet P as shown in FIGS. 3-5. In other words, the first and second wheeled assemblies respectively comprise first and second receivers R that are adapted to operatively engage wedge interface members PX of the associated pallet P. FIG. 6 is an isometric view of the wheeled assembly WA1,WA2 and FIG. 7 is an enlarged partial isometric view of the wheeled assembly WA1,WA2 showing the pallet receiver R. FIG. 8 is an enlarged partial side view that shows a first or second side S1,S2 of an associated 463L pallet operatively engaged with the receiver R such that at least two and optionally all of the pallet wedge interface members PX are received and retained in the receiver R. In these views, it can be seen that the pallet receiver R includes a first or upper portion R1 (FIG. 8) and a second or lower portion R2 that is spaced-apart from the first (upper) portion R1 such that a slot RS is defined between the first (upper) and second (lower) portions R1,R2 that is adapted to receive and engage with the pallet wedge interface members PX located on the first and second sides of the pallet P and such that the upper wedge surface PX1 of the wedge interface member PX abuts the first (upper) receiver portion R1 and the lower wedge surface PX2 of the wedge interface member PX abuts the second (lower) receiver portion R2 and the wedge interface member PX is captured in the receiver R and unable to move further into the receiver R in an insertion direction ID and is unable to move in any direction except linearly in a withdrawal direction WD that is opposite the insertion direction ID along a withdrawal axis WX that lies parallel to the pallet upper surface SK1. In the illustrated example, the second (lower) receiver portion can comprise a receiver lip RL located at and projecting outwardly from a lower portion FL of the frame F that is closest to the ground or other support surface on which the wheeled assembly WA1,WA2 is supported. The receiver lip RL can extend in one-piece continuously and uninterruptedly laterally across the frame F between the first and second lateral sides or the receiver lip RL can include two or more separate and laterally spaced-apart separate lip segments that are distributed evenly or otherwise between the first and second opposite lateral sides F1,F2 of the frame F. The receiver lip RL is angled away from the frame F downwardly toward the ground or other support surface as it extends forwardly away from the frame F. In particular, the receiver lip RL is angled at an engagement angle relative to horizontal that complements the angle of the lower wedge surface PX2 of each wedge interface member PX so that the lower wedge surface PX2 closely mates with an abuts the receiver lip RL when the wedge interface members PX are received in the receiver R as shown in FIG. 8. The first (upper) receiver portion R1 can comprise a cross-bar XB that lies parallel to the receiver lip RL and that is spaced-apart from and above the receiver lip RL such that the receiver slot RS is defined between the cross-bar XB and the lip RL. The cross-bar XB or other first (upper) receiver portion R1 can be provided as one continuous uninterrupted tube or other member that extends laterally across the frame F between the first and second lateral sides of the frame, or the cross-bar XB or other first (upper) receiver portion R1 can be segmented and comprises separate segments that are spaced laterally apart from each other and spaced evenly or unevenly between the opposite lateral sides of the frame F. As shown in FIG. 8, when the pallet wedge interface members PX are fully engaged into the receiver R, upper wedge surface PX1 is abutted with the cross-bar XB or other first (upper) receiver portion R1 and the lower wedge surface PX2 is abutted with the lip R or other second (lower) receiver portion R2, and the wedge interface members PX are restrained against any movement except in the withdrawal direction WD, unless the pallet mobilizer PM is fully assembled into its operative position about the pallet P as described in which case the wedge interface members PX are also restrained against movement in the withdrawal direction WD.

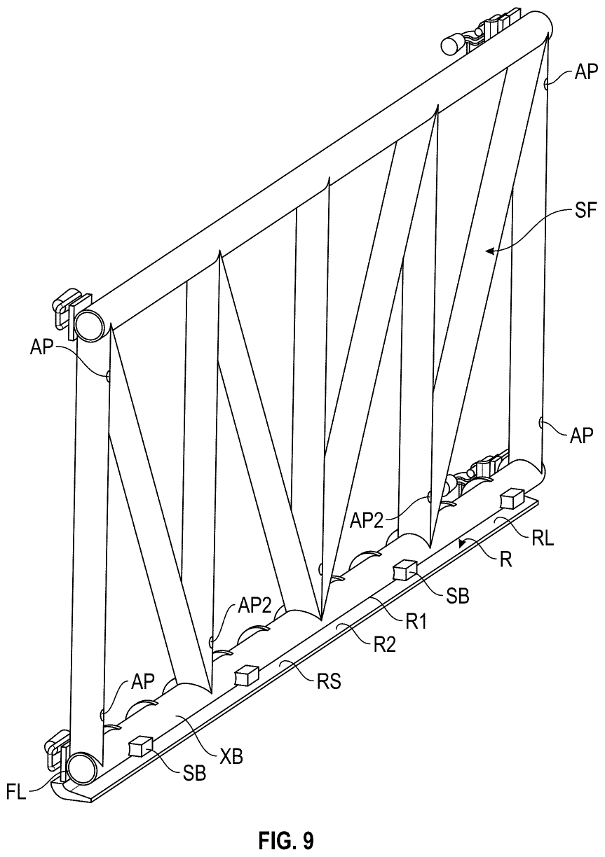

The first and second side rails SR1,SR2 each also include a side rail pallet receiver R as described in relation to the first and second wheeled assemblies WA1,WA2. In other words, the first and second side rails SR1,SR2 respectively comprise first and second side rail pallet receivers R. In particular, as shown in FIG. 9, each side rail frame SF includes a pallet receiver R that selectively mates with and engages at least two and preferably multiple or all of the wedge interface members PX on the third or fourth side S3,S3 of the pallet P as shown in FIGS. 3-5. FIG. 9 shows that the frame SF of each side rail SR1,SR2 can comprise a pallet receiver R including a first or upper portion R1 and a second or lower portion R2 that is spaced-apart from the first (upper) portion R1 such that a receiver slot RS is defined between the first (upper) and second (lower) portions R1,R2 that is adapted to receive and engage with the pallet wedge interface members PX located on the first and second sides of the pallet P and such that the upper wedge surface PX1 of the wedge interface member PX abuts the first (upper) receiver portion R1 and the lower wedge surface PX2 of the wedge interface member PX abuts the second (lower) receiver portion R2 and the wedge interface member PX is captured in the receiver R in the same manner as described above for the receiver R of the first and second wheeled assemblies WA1,WA2. Since the pallet receiver R of each side rail SR1,SR2 is structured and functions similarly or identically to the pallet receiver R of each wheeled assembly WA1,WA2, the pallet receiver R of each side rail SR1,SR2 is not further described here. As shown in FIG. 9, the cross-member XB of the receiver R of the side rail SR1,SR2 (and/or the receiver R of the wheeled assembly WA1,WA2) can comprise one or more stop blocks SB that abut the side S3,S4 (or S1,S2) of the pallet P when the pallet wedge interfaces PX are fully engaged in the receiver R.

As disclosed above:
a first receiver R is provided on the first wheeled assembly WA1 for selectively mating with and engaging at least two and preferably multiple or all of the wedge interface members PX on the first side S1 (or second side S2) of the pallet P;
a second receiver R is provided on the second wheeled assembly WA2 for selectively mating with and engaging at least two and preferably multiple or all of the wedge interface members PX on the second side S2 (or first side S1) of the pallet P;
a third receiver R is provided on the first side rail SR1 for selectively mating with and engaging at least two and preferably multiple or all of the wedge interface members PX on the third side S3 (or fourth side S4) of the pallet P;
a fourth receiver R is provided on the second side rail SR2 for selectively mating with and engaging at least two and preferably multiple or all of the wedge interface members PX on the fourth side S4 (or third side S3) of the pallet P.

In the illustrated embodiment, both the first and second wheeled assemblies WA1,WA2 and the first and second side rails SR1,SR2 include a pallet receiver R for selectively being engaged with the pallet wedge interfaces PX on the sides S1-S4 of the pallet P. Those of ordinary skill in the art will recognize that, in alternative embodiments, the pallet receiver R can optionally be: (i) omitted from the first and second side rails SR1,SR2 if the receiver R is included on both the first and second wheeled assemblies WA1,WA2; or (ii) omitted from the first and second wheeled assemblies WA1,WA2 if the receiver R is included on both of the first and second side rails SR1,SR2.

To mobilize a pallet P, the pallet mobilizer PM is assembled into its operative position in operative engagement with an associated pallet P. As noted above, operative engagement with a pallet P means that at least two receivers R are provided and operatively engaged with opposite sides S1-S4 of the pallet P. In the illustrated embodiment described below, both the first and second wheeled assemblies WA1,WA2 and the first and second side rails SR1,SR2 include a pallet receiver R, and the process of operative engagement with a pallet P is described as engaging all of these four receivers R with all four sides S1-S4 of the pallet P, but those of ordinary skill in the art will recognized that the pallet engagement process can be varied if the receivers R are omitted for either the side rails SR1,SR2 or the wheeled assemblies WA1,WA2. As shown in FIG. 2B and FIG. 8, the first and second wheeled assemblies WA1,WA2 are respectively moved into operative engagement with the opposite first and second sides S1,S2 of the pallet P with the pallet interface members PX inserted into and engaged by the pallet receivers R of the first and second wheeled assemblies WA1,WA2, and the first and second side rails SR1,SR2 are moved into operative engagement with the third and fourth opposite sides S3,S4 of the pallet P with the pallet interface members PX inserted into and engaged by the pallet receivers R of the first and second side rails SR1,SR2. After the first and second wheeled assemblies WA1,WA2 and first and second side rails SR1,SR2 are respectively positioned adjacent and in engagement with the first, second, third, and fourth pallet sides S1-S4, the latches L are operated to fixedly secure and connect both of the first and second side rails SR1,SR2 to both of the first and second wheeled assemblies WA1,WA2 to form the pallet mobilizer system PS as described above and as shown in FIGS. 3-5. The safety pins SP can be inserted through aligned apertures AP defined in the frame F of each wheeled assembly WA1,WA2 and the frame F of each side rail SR1,SR2 to prevent separation of the side rails SR1,SR2 from the wheeled assemblies WA1,WA2 in the event one or more of the latches L fails or opens inadvertently.

To move or mobilize the pallet P, the one or more jack assemblies J1,J2 of both the first and second wheeled assemblies WA1,WA2 are operated to raise the frame F of the first and second wheeled assemblies WA1,WA2 (and also the operatively engaged pallet P and the first and second side rails SR1,SR2) relative to each chassis C and away from the ground or other support surface so that the pallet mobilizer PM can be moved (rolled) on its rolling wheel assemblies RW (the brake BK of each rolling wheel assembly RW must be disengaged to allow such rolling movement of the pallet mobilizer PM). Each wheeled assembly WA1,WA2 includes a push bar PB for one or more users to push the pallet mobilizer PM manually. As noted, a tow bar TB can be provided and each wheeled assembly WA1,WA2 can include one or more (two as shown) tow loops TL connected to the chassis C or other location of the body that can be engaged by the tow bar TB. The opposite end of the tow bar TB can be connected to a vehicle V as shown in Exhibit A that can tow the pallet mobilizer in either its operative or stowed configuration.

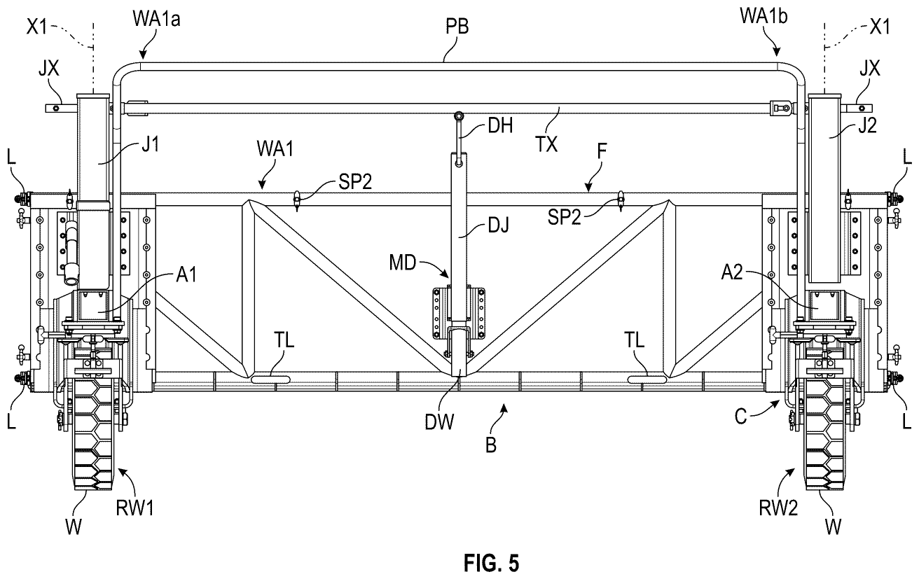

As shown in FIGS. 3, 5, & 6, the first and second wheeled assemblies WA1,WA2 can comprise a maneuvering jack or maneuvering dolly MD including a dolly wheel DW connected to a dolly jack mechanism DJ comprising a handle DH that can be selectively manually rotated in a first direction to extend the dolly jack DJ so that the dolly wheel DW engages the ground or other support surface G to facilitate maneuvering the wheeled assembly WA1,WA2 by itself and/or as part of the process of engaging the wheeled assembly with and/or disengaging the wheeled assembly from a pallet P. When extended into contact with the support surface G, the dolly wheel DW cooperates with the first and/or second rolling wheel assembly RW1,RW2 to movably (rollably) support the wheeled assembly WA1,WA2 on the ground or floor support surface G. The dolly handle DH can be rotated in the first direction and in an opposite second direction to extend and retract the dolly wheel DW, respectively, to raise and lower the height of the receiver R to facilitate mating of the receiver R with the wedge interface members PX of a pallet P. The When the maneuvering is complete, the dolly handle DH can be manually rotated in a second direction opposite the first direction to retract the dolly jack DJ and dolly wheel DW connected thereto from the extended operative position to a retracted inoperative or stowed position where the dolly wheel is not engaged with the ground or other support surface on which the wheeled assembly WA1,WA2 is supported. In the illustrated example, the maneuvering dolly MD is connected to the frame F.

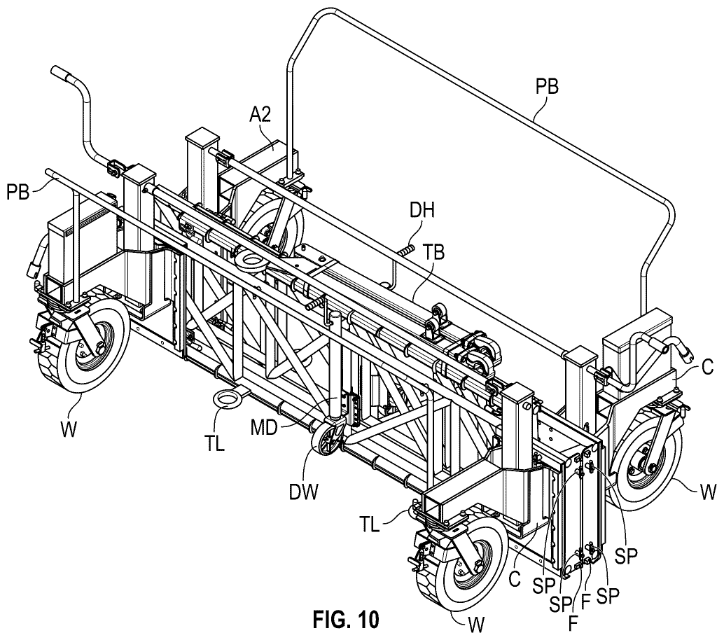

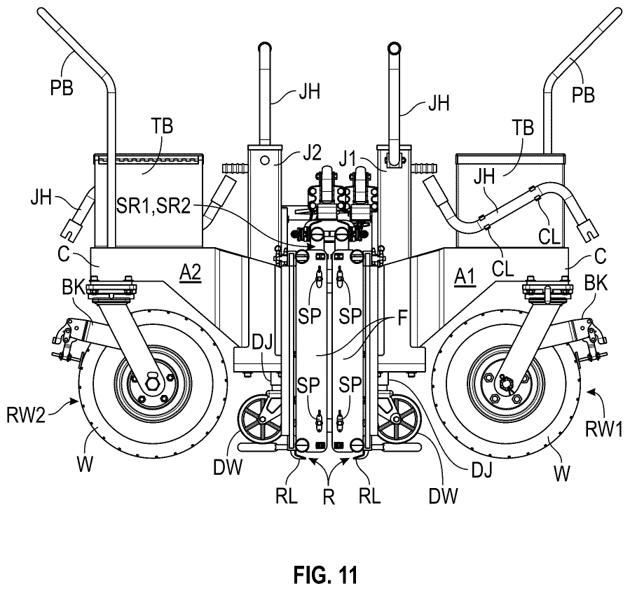

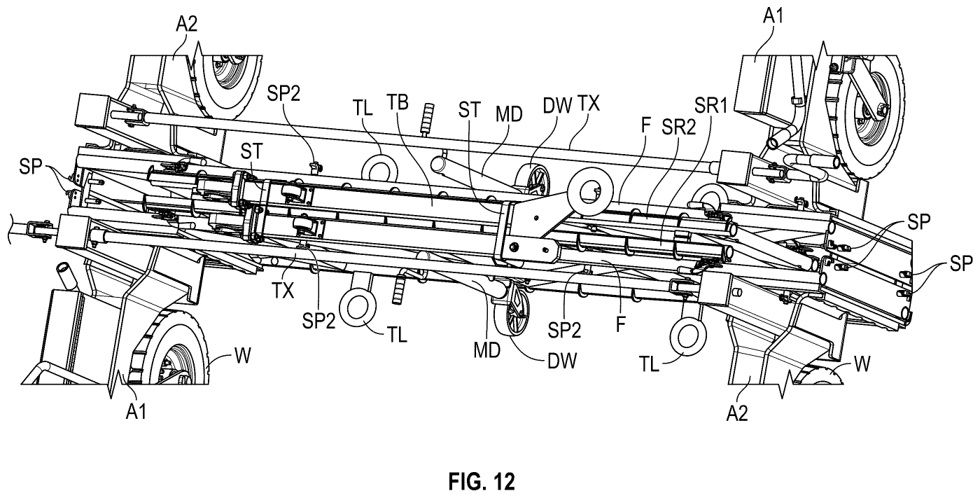

When not in operative use to mobilize a pallet P, the pallet mobilizer PM can be selectively disassembled into its separate components (as shown in FIG. 2A) by reversing the above-described assembly process, and these separate components WA1,WA2,SR1,SR2,TB of the pallet mobilizer PM can be selectively assembled in a packed or stowed configuration as shown in FIGS. 10-12 for more compact storage and transport. To maintain the pallet mobilizer PM in its stowed configuration, safety pins SP are inserted into aligned apertures AP of the frames F of the respective first and second wheeled assemblies WA1,WA2 to prevent separation of these components while the safety pins SP are installed in the aligned apertures AP. In this stowed/packed configuration, the side rails SR1,SR2 are placed parallel to each other and also parallel to the frames F of both the first and second wheeled assemblies WA1,WA2 and the side rails SR1,SR2 are then captured between the adjacent frames F of the first and second wheeled assemblies WA1,WA2. Safety pins SP2 are also inserted into aligned or registered apertures AP2 (see also FIGS. 6 & 9) of the side rails SR1,SR2 to fixedly secure the side rails SR1,SR2 to the frames F of the wheeled assemblies WA1,WA2 in this stowed position. When the pallet mobilizer PM is in its stowed or packed configuration, the optional tow bar TB can be strapped, pinned, or otherwise secured to one or both the side rails SR1,SR2 between the first and second wheeled assemblies WA1,WA2 (straps ST are shown in the illustrated example).The safety pins SP,SP2 are manually removed to allow the components of the pallet mobilizer PM to be disassembled from the packed/stowed configuration and reassembled into the operative configuration as described above.

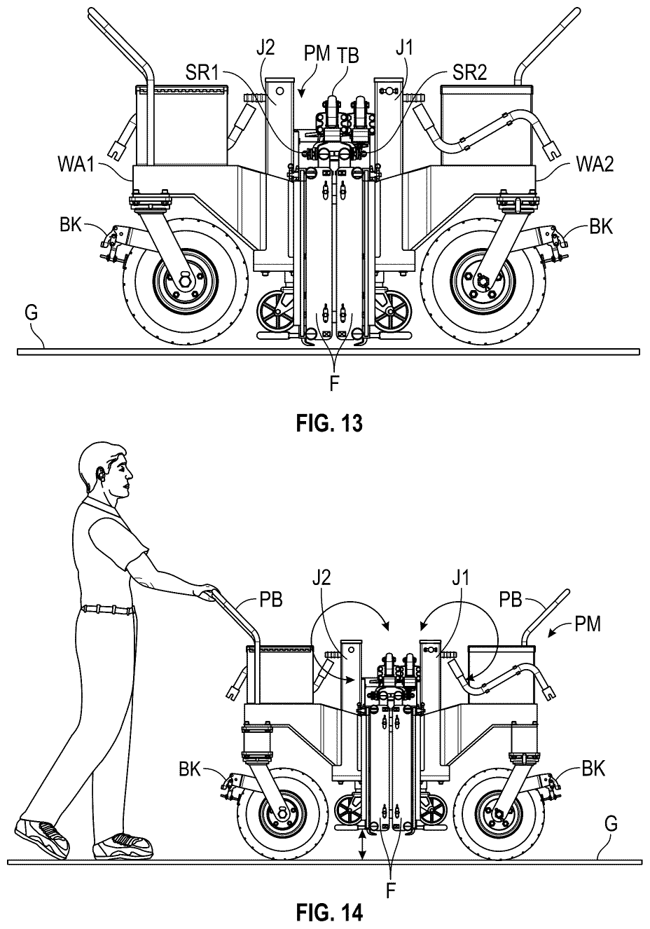

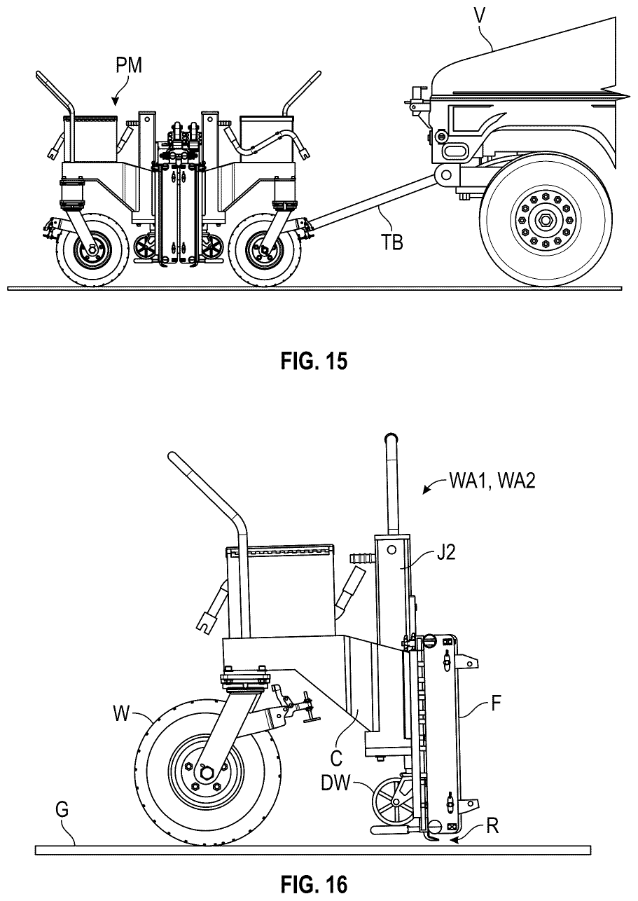

As shown in FIG. 13, in the stowed configuration, the pallet mobilizer PM can be parked with the brakes BK engaged and with the jack assemblies J1,J2 of each wheeled assembly WA1,WA2 lowered so that the wheel assembly frames F are in contact with or close to the floor or ground G. In FIG. 14, the jack assemblies J1,J2 of each wheeled assembly WA1,WA2 can be selectively operated to raise the frame F of each wheeled assembly WA1,WA2 and the brakes BK can be disengaged to allow the pallet mobilizer PM, in its stowed or packed configuration, to be moved across the floor or ground G manually via push bars PB or using a vehicle to tow the pallet mobilizer PM using the tow bar TB connected to at least one tow loop TL and an associated vehicle V as shown in FIG. 15.

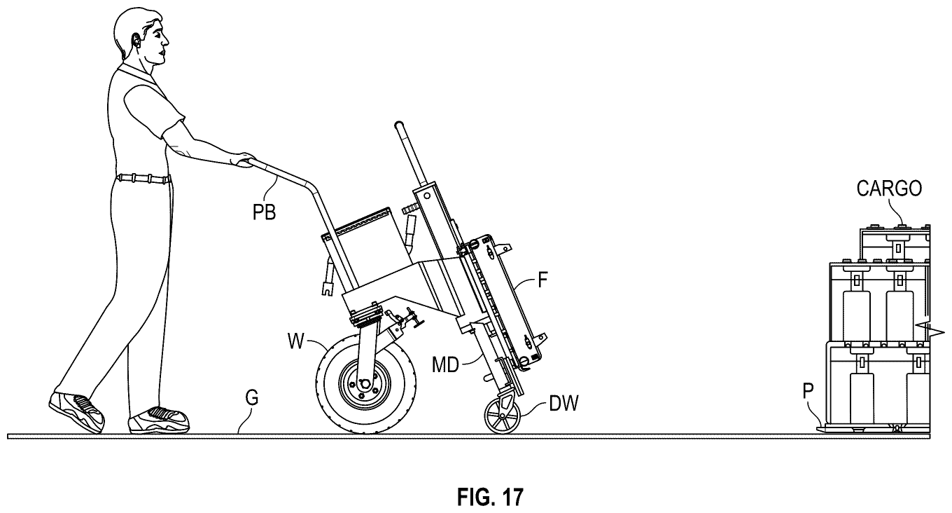

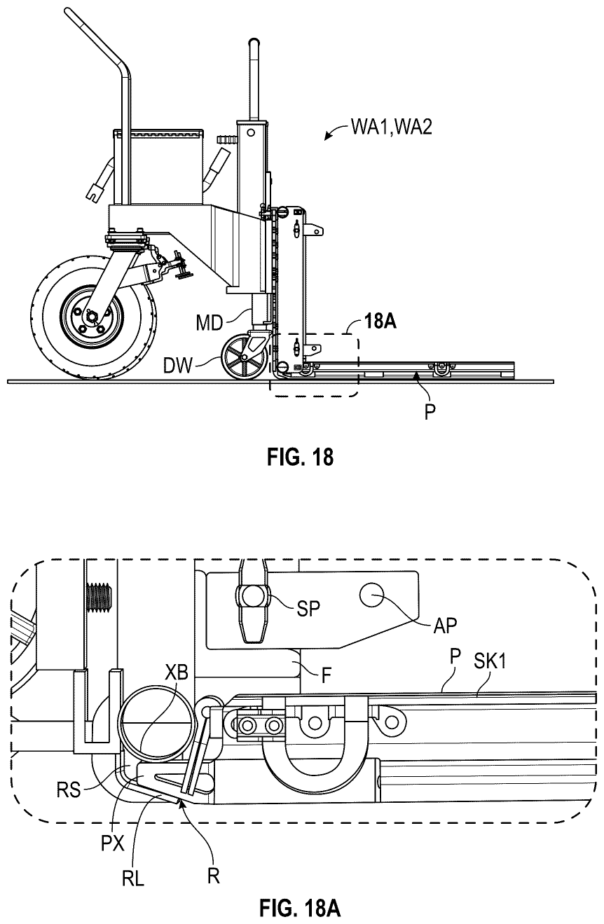

FIG. 16 shows that each wheeled assembly WA1,WA2 can be placed such that its frame F contacts the floor or ground when not in use. As shown in FIG. 17 the maneuvering dolly MD can be selectively operated to extend the dolly wheel DW to allow the wheeled assembly WA1,WA2 to be easily rolled and maneuvered across the floor or ground G by manual pushing on the push bar PB. FIG. 18 shows that the maneuvering dolly MD can be operated to position the pallet receiver R of the wheeled assembly WA1,WA2 at the proper height relative to the support surface G to align with the wedge interface members PX of the pallet P to be engaged such that the wedge interface members PX of the pallet P are received into the receiver R as shown in the partial enlarged view of FIG. 18A.

A pallet mobilizer PM is provided for selectively engaging and moving empty or fully loaded 463L pallets P without the aid of a forklift is provided. The pallet mobilizer PM disclosed herein provides at least the following functions and advantages and others:
the pallet mobilizer PM connects to a “loaded” the 463L pallet P even when the pallet is directly on the floor or ground, without requiring the pallet to be supported on dunnage;
the pallet mobilizer PM lifts the pallet P providing ground clearance for movement;
the pallet mobilizer PM can roll-on or roll-off an aircraft or truck using a ramp;
the pallet mobilizer PM has a connection location for connecting to a winch of an aircraft or truck to pull the pallet mobilizer PM (with the loaded or empty pallet P carried thereby) up a ramp for loading and/or for lowering the pallet mobilizer PM (with the loaded or empty pallet P carried thereby) down the ramp to control its descent;
the pallet mobilizer PM has wheels for maneuvering or moving the whole pallet P;
the pallet mobilizer PM includes manual push bars for human movement of the pallet mobilizer and associated pallet P;
the pallet mobilizer PM includes a tow bar for low-speed vehicle towing;
the pallet mobilizer PM is manually operated, so power is not required for its operation;
the pallet mobilizer PM breaks down to a small package with all parts latched and secured when not in use and can be pushed or towed even when in its stowed mode/configuration and not connected to a 463L pallet P;
the pallet mobilizer is structurally designed to move full 463L pallet P loaded with up to 10,000 lbs. of cargo.

Although the present development has been described herein in relation to the first and second wheeled assemblies WA1,WA2 being engaged with the first and second sides S1,S2 of the pallet P and the first and second side rails SR1,SR2 being engaged with the third and fourth sides S3,S4 of the pallet P, these relative positions can be swapped in an alternative embodiment such that the first and second wheeled assemblies WA1,WA2 are dimensioned to be engaged with the third and fourth sides S3,S4 of the pallet P and the first and second side rails SR1,SR2 are dimensioned to be engaged with the first and second sides S1,S2 of the pallet P.

The development has been described with reference to preferred embodiments. Modifications and alterations will occur to those of ordinary skill in the art to which the invention pertains, and it is intended that the specification be construed as encompassing all such modifications and alterations.

1. A pallet mobilizer for selectively engaging and moving an associated pallet on a support surface, said pallet mobilizer comprising:
first and second wheeled assemblies and first and second side rails, wherein the first and second wheeled assemblies comprise respective first and second receivers for selectively engaging wedge interface members located on the associated pallet, and wherein the first and second wheeled assemblies can be arranged in opposed facing relation on opposite first and second sides of the associated pallet and the first and second side rails can be arranged in opposed facing relation on opposite third and fourth sides of the associated pallet, with the first and second side rails extending between and connected to both the first and second wheeled assemblies.

2. The pallet mobilizer as set forth in claim 1, wherein said first and second side rails comprise respective receivers for engaging said wedge interface members located on the associated pallet.

3. The pallet mobilizer as set forth in claim 1, wherein said first and second wheeled assemblies each comprise at least one rolling wheel assembly for movably supporting said respective wheeled assembly on a support surface.

4. The pallet mobilizer as set forth in claim 3, wherein said first and second wheeled assemblies each comprise first and second rolling wheel assemblies.

5. The pallet mobilizer as set forth in claim 4, wherein said first and second wheeled assemblies each comprises a body including: (i) a chassis to which said at least one rolling wheel assembly is connected; and (ii) a frame that is connected to said chassis and that is adapted to move relative to said chassis.

6. The pallet mobilizer as set forth in claim 5, wherein each of said first and second wheeled assemblies further comprises a jack that moves said frame relative to said chassis when actuated.

7. The pallet mobilizer as set forth in claim 6, wherein each of said first and second wheeled assemblies further comprises a maneuvering dolly connected to the frame and comprising a dolly wheel and a dolly jack that is selectively operable to extend said dolly wheel relative to said frame such that said dolly wheel movably supports said frame on a support surface.

8. The pallet mobilizer as set forth in claim 1, wherein the first and second wheeled assembly receivers each comprise first and second receiver portions that define a receiver slot therebetween.

9. The pallet mobilizer as set forth in claim 2, wherein the pallet mobilizer can be selectively configured in an operative position engaged with the associate pallet or in an inoperative or stowed configuration in which the first and second wheeled assemblies are located adjacent each other and connected together, with the first and second side rails located between and carried by the first and second wheeled assemblies.

10. The pallet mobilizer as set forth in claim 1 comprising at least one of: (i) a push bar connected to at least one of the first and second wheeled assemblies; (ii) a tow bar adapted to be connected at a first tow bar end to at least one of the first and second wheeled assemblies and adapted to be connected at an opposite second tow bar end to an associated towing vehicle.

11. The pallet mobilizer as set forth in claim 4, wherein the at least one of the first and second rolling wheel assemblies of each of the first and second wheeled assemblies comprises a selectively actuated brake for inhibiting rotation of a wheel of the at least one rolling wheel assembly.

12. A method of mobilizing a pallet comprising engaging the pallet with first and second wheeled assemblies that movably support the pallet on a support surface, wherein a first receiver provided on the first wheeled assembly is engaged with a first edge of the pallet and a second receiver provided on the second wheeled assembly is engaged with a second edge of the pallet that is opposite the first edge of the pallet.

13. The method as set forth in claim 12, further comprising engaging the pallet with first and second side rails that extend between and interconnect the first and second wheeled assemblies, wherein a third receiver provided on the first side rail is engaged with a third edge of the pallet and a fourth receiver provided on the second side rail is engaged with a fourth edge of the pallet that is opposite the third edge of the pallet.

14. The method as set forth in claim 13, further comprising pushing or towing the first and second wheeled assemblies across the support surface while said first and second wheeled assemblies are engaged with the pallet.

15. The method as set forth in claim 14, wherein said first and second wheeled assemblies comprise: (i) respective first and second chassis each including first and second rolling wheel assemblies; and (ii) respective first and second frames connected respectively to the first and second chassis, wherein said first frame includes a first pallet receiver and said second frame includes a second pallet receiver, said method further comprising raising and lowering the first and second frames relative to the first and second chassis, respectively, to adjust a position of the first and second pallet receivers relative to a support surface on which the first and second rolling wheel assemblies of both said first and second chassis are supported.

16. A pallet mobilizer for selectively engaging and moving an associated pallet on a support surface, said pallet mobilizer comprising:
a first wheeled assembly including a first frame including a first receiver adapted to be located adjacent and engaged with a first edge of the associated pallet;
a second wheeled assembly including a second frame including a second receiver adapted to be located adjacent and engaged with a second edge of the associated pallet that is parallel to and spaced-apart from the first edge;
a first side rail adapted to be located adjacent a third edge of the associated pallet, said first side rail connected to and extending between the first and second frames;
a second side rail adapted to be located adjacent a fourth edge of the associated pallet, said second side rail connected to and extending between the first and second frames.

17. The pallet mobilizer as set forth in claim 16, wherein the first and second frames are respectively connected to and selectively movable relative to first and second chassis.

18. The pallet mobilizer as set forth in claim 17, wherein said first and second wheeled assemblies respectively comprise first and second jack assemblies that are respectively operably connected to and selectively operable to raise and lower the first and second frames relative to the first and second chassis.

19. The pallet mobilizer as set forth in claim 18, wherein the first and second chassis each comprise at least one rolling wheel assembly.

20. The pallet mobilizer as set forth in claim 19, wherein each of said first and second wheeled assemblies further comprises a maneuvering dolly connected to the frame and comprising a dolly wheel and a dolly jack that is selectively operable to extend said dolly wheel relative to said frame such that said dolly wheel cooperates with the at least one rolling wheel assembly to movably support said frame on a support surface.
